(19) United States
(12) Patent Application Publication
(10) Pub. No.: US 2009/0232183 A1
(43) Pub. Date: Sep. 17, 2009

(54) SYSTEM AND METHOD TO MEASURE TEMPERATURE IN AN ELECTRIC MACHINE

(75) Inventors: Sameh Ramadan Salem, Rexford, NY (US); Alan Michael Iversen, Clifton Park, NY (US); Ronald Irving Longwell, Ballston Lake, NY (US); Adrian Matthew Breitenstein, JR., Delanson, NY (US); Lawrence Lee Sowers, Ballston Lake, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/047,775

(22) Filed: Mar. 13, 2008

(51) Int. Cl. G01K 11/32; G02B 6/00

(52) U.S. Cl. 374/161; 385/12

(57) ABSTRACT

A system and method to measure a characteristic of a component of an electric machine. The system includes an optical fiber disposed proximate to the component, at least one sensor, disposed along the optical fiber, to detect the temperature of the component, and a data acquisition system operably coupled to the sensor via the optical fiber to generate real-time data in accordance with the detected temperature of the component during an operation of the electric machines.

### BACKGROUND

The subject invention relates to electric machines and, more particularly, the subject invention relates to the monitoring of temperature in electric machines.

Electric machines may be, for example, turbine-generators, hydro-generators, motors, and wind-generators. Typically, the electric machines include various components, such as core iron, stator bars and a stator flange. The core iron, which comprises thousands of laminations, the stator bars and the stator flange, may themselves support copper windings, which are threaded through the components and along which electric currents flow when the electric machines are operated. While this current does not normally cause temperatures of the various components to rise significantly, local overheating, particularly with respect to the laminations, has been observed when the copper windings or some other feature within the electric machines malfunction. In this case, if the overheating is excessive (i.e., if the laminations are heated to a temperature above the melting point of their respective materials), damage to the electric machine may ensue.

Currently, various methods and systems, such as resistance temperature detection (RTD) and temperature coefficient (TC) monitoring systems, are used to evaluate, e.g., core iron temperatures. These methods and systems, however, rely upon components that are sensitive to electro-magnetic interference similar to that which is caused by the electric machines and, thus, the electric machines must be off-line to perform the necessary measurements. Additionally, the current methods and systems tend to be operator sensitive and subject to an operator's interpretation of the results. Further, the electrical machines must be at least partially disassembled to allow the measurements to be performed. The disassembly of the machines increases machine downtime and associated costs.

### BRIEF DESCRIPTION OF THE INVENTION

In accordance with an aspect of the invention, a system to measure a temperature of a component of an electric machine is provided and includes an optical fiber disposed proximate to the component, at least one sensor, disposed along the optical fiber, to detect the temperature of the component, and a data acquisition system operably coupled to the sensor via the optical fiber to generate real-time data in accordance with the detected temperature of the component during an operation of the electric machine.

In accordance with another aspect of the invention, a system to measure temperatures of components of an electric machine is provided and includes a first set of sensors, disposed along optical fibers and dispersed from one another at a first interval in a predetermined direction relative to the components, to each detect a temperature of corresponding local portions of the components, a second set of sensors, disposed along optical fibers proximate to a hot-spot of the components and dispersed from one another at a second interval in the predetermined direction, to each detect a temperature of corresponding local portions of the components, and a data acquisition system operably coupled to each of the first and second set of the sensors via the optical fibers to generate real-time temperature data in accordance with the detected temperatures.

In accordance with another aspect of the invention, a method of operating an electric machine by monitoring temperatures of components thereof is provided and includes installing a set of optical fibers, including sensors configured to detect temperatures of the components, at various positions proximate to the components, and interrogating each of the sensors so as to generate real-time temperature data of the components, while the electric machine is in operation, in accordance with the detected temperatures.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a perspective view of components of an electric machine;

FIG. 2 is a magnified perspective view of components of an electric machine; and

FIG. 3 is a schematic view of an optical fiber and a data acquisition

system.

### DETAILED DESCRIPTION OF THE INVENTION

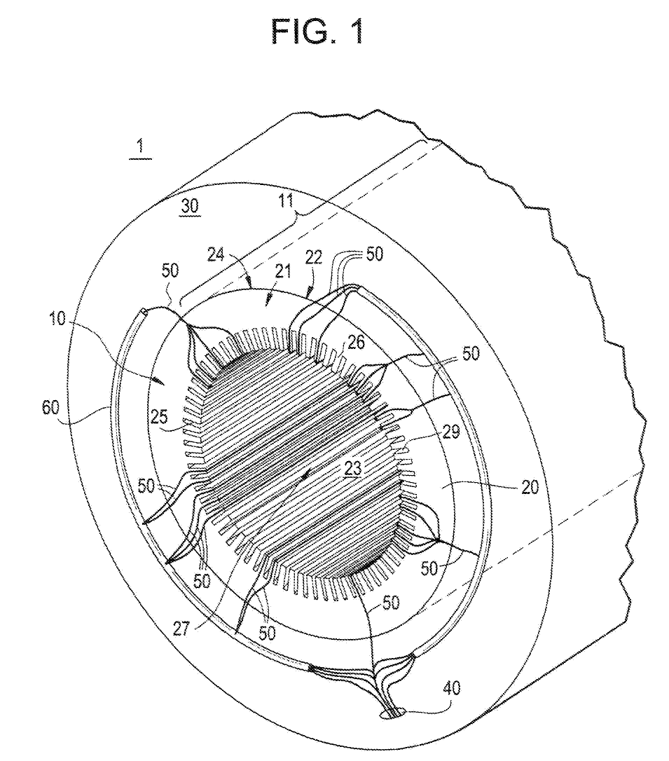

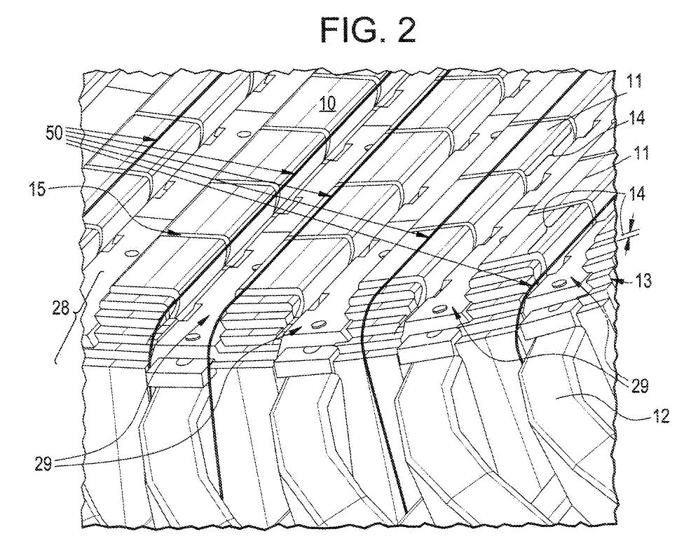

Referring to FIGS. 1 and 2, an electric machine 1 includes components, such as core iron 10, which itself includes a lamination stack 11 and stator bars 12, which are disposed at distal ends of the lamination stack 11, field windings (not shown), stator endwinding components, stator electrical components and bus work. The lamination stack 11 comprises stacked laminations 13 that are organized into lamination packages 14 of various sizes. Band gaps 15, through which ventilation gas is allowed to flow, are defined between some of the lamination packages 14.

With reference to FIG. 1, each lamination 13 includes a body 20 having opposing annular faces 21 and 22 and an aperture 23 extending through the body 20 from one face 21 to the other 22. The body 20 includes an exterior surface 24 and an interior surface 25. The interior surface 25 includes annularly arranged teeth 26 that form an inner border of the body 20 and an outer border of the aperture 23. When the laminations 13 are assembled together to form the lamination stack 11, the lamination stack 11 includes a through-hole 27 defined therein along an axis thereof.

With reference to FIG. 2, the laminations 13 at distal ends of the lamination stack 11 form stepwise lamination packages 14, in which the corresponding apertures 23 of the local laminations 13 have slightly larger diameters than those of other laminations 13. Thus, when these local laminations 13 are assembled, relatively rounded distal edges 28 of the through-hole 27 are formed. Further, when the lamination stack 11 is assembled, the teeth 26 form an annular series of axially extending core slots 29.

With reference back to FIG. 1, the core iron 10 is at least partially encased by a frame 30 that seals the core iron 10 and which is penetrated by a gas tight gland 40 through which the ventilation gas is injected and through which at least one optical fiber sensor 50 is drawn toward the core iron 10. A rail 60 supports the optical fiber sensor 50 at any one of various positions around the core iron 30. In various embodiments, the optical fiber sensor 50 is plural in number with each of the optical fiber sensors 50 being simultaneously supported at various circumferential positions around the core iron 10.

In accordance with embodiments of the invention, the optical fiber sensors 50 may be bonded to an interior of the core iron 10 along the laminations 13, the stator bars 12 or any other components to which the optical fiber sensors 50 are to be attached. The bonding may be accomplished by the use of epoxy or other similar adhesives. In another embodiment, the optical fiber sensors 50 may be embedded into the laminations 13, the stator bars 12 or any other components to which the optical fiber sensors 50 are to be attached during manufacturing processes thereof.

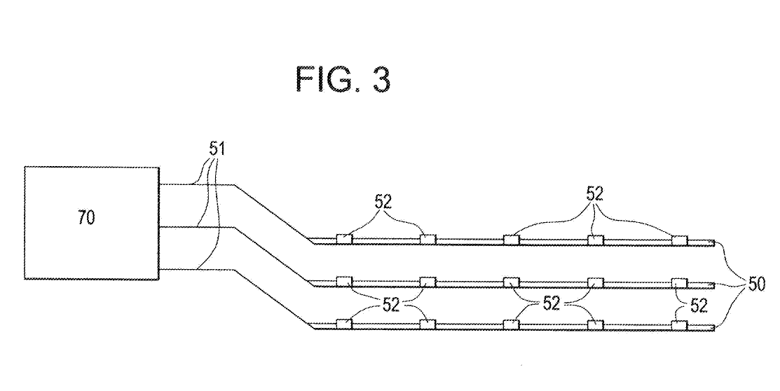

With reference now to FIG. 3, the optical fiber sensors 50 each comprise a fiber optic cable 51 along which a plurality of sensors 52 are distributed at a predetermined spatial interval, which may be, e.g., about 1 cm. The sensors 52 may comprise Bragg grating sensors or any other similar sensor. The optical fiber sensors 50 are operably coupled to a data acquisition system 70. The optical fiber sensors 50 and the data acquisition system 70 may be obtained, for example, from Luna Innovations which provides such under its marketing name, “Distributed Sensing System.”

In an embodiment, the data acquisition system 70 is configured to interrogate the sensors 52 by transmitting a signal to each of the sensors 52 along the fiber optic cables 51 with each of the sensors 52 then reflecting a signal back to the data acquisition system 70. Each of the reflected signals is indicative of temperatures of components that are local to and/or proximate to the corresponding sensor 52. In a further embodiment, the reflected signal from each of the sensors 52 may be modulated by a unique frequency. This allows the data acquisition system 70 to apply filtering operations to the reflected signals to thereby retrieve and identify data of the particular reflected signal of each of the sensors 52.

Since the data acquisition system 70 interrogates the sensors 52, which are provided at a predetermined spatial interval, the data acquisition system 70 is configured to generate a distributed temperature profile of the core iron 10 and the stator bars 12 and any other component to which the optical fiber sensors 50 are attached. Moreover, the predetermined spatial interval between the sensors 52 or the orientation of the fiber optic cables may be varied. That is, the predetermined spatial interval between the sensors 52 or the orientation of the fiber optic cables 51 may be chosen such that at least one or more sensors 52 is/are located in a known hot-spot of the core iron 10, such as along certain laminations 13 or proximate to the stator bars 12, in order to provide detailed temperature measurements at areas of likely temperature increases. Such hot-spots can be identified by sensors 52 dispersed at spatial intervals of 1 cm from one another, and then monitored by modifying increasing the number of sensors 52 proximate to the hot-spot.

For example, the relatively rounded distal edges 28 of the through-hole 27 of the core iron 10 may be subject to axial electromagnetic flux that tends to cause increased temperatures. As such, in an embodiment of the invention, the fiber optic cables 51 may be disposed to traverse the rounded distal edges 28 at an oblique angle such that a dispersion of the corresponding sensors 52 is increased proximate to the rounded distal edges 28. As alternate embodiments, the fiber optic cables 51 may be arranged near the relatively rounded distal edges 28 in oscillating patterns or staggered with respect to one another such that a number of corresponding sensors 52 is increased.

During an operation of the electric machine 1, the components of the electric machine 1, such as the laminations 13 or the stator bars 12, may experience temperature changes that can be tracked by the optical fiber sensors 50. That is, an exemplary temperature change may involve a temperature increase of an individual lamination 13 that is either directly observable by a local sensor 52 or which results in measurements of tension/compression in the local sensor 52. The data acquisition system 70 measures the observed temperature increase or the positive/negative strain and interprets the measurement as indicative of the temperature increase.

As the components of the electric machine 1 experience temperature changes during operations thereof, increases in the measured temperatures may reflect a need for service or replacements. For example, where the measured temperature of a lamination 13 exceeds a melting point of the materials used in the construction of the lamination 13, the lamination 13 and its neighboring laminations 13 may be identified as being in need of replacement. However, since a utilization of the optical fiber sensors 50 allows for real-time measurements of temperatures of the components of the electric machine 1 consistently during operations thereof, consistent monitoring of the measurements is made possible. As such, issues relating to increased temperatures of the components may be resolved before the measured temperatures exceed damage causing levels.

This written description uses examples to disclose the invention, including the best mode, and also to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system to measure a temperature of a component of an electric machine, the system comprising:
an optical fiber disposed proximate to the component;
at least one sensor, disposed along the optical fiber, to detect the temperature of the component; and
a data acquisition system operably coupled to the at least one sensor via the optical fiber to generate real-time data in accordance with the detected temperature of the component during an operation of the electric machine.

2. The system according to claim 1, wherein the optical fiber is stress transmissively coupled to the component.

3. The system according to claim 1, wherein the optical fiber is bonded to the component via adhesive.

4. The system according to claim 1, wherein the optical fiber is embedded in the component.

5. The system according to claim 1, wherein the component is provided within core iron of the electric machine, is plural in number and comprises:
a lamination assembled in a stack of laminations; and
a set of stator bars disposed at distal ends of the stack of laminations.

6. The system according to claim 5, wherein each of the laminations within the stack comprises:
a body having first and second annular faces; and
an aperture extending through the body from the first face to the second face.

7. The system according to claim 6, wherein an inner border of each of the laminations comprises a series of annularly arranged teeth through which copper windings, along which currents flow during the operation of the electric machine, are threaded.

8. The system according to claim 6, wherein the optical fiber is disposed proximate to and/or between the teeth and/or proximate to the stator bars.

9. The system according to claim 1, wherein the at least one sensor comprises a Bragg grating sensor.

10. The system according to claim 1, wherein the component and the at least one sensor are plural in number with each sensor being disposed along the optical fiber at a predetermined interval so as to be proximate to a local set of the plural components.

11. The system according to claim 10, wherein the predetermined interval is set at about 1 cm.

12. The system according to claim 10, wherein the data acquisition system is configured to transmit a signal to each sensor, which then reflects the signal back to the data acquisition system so as to be indicative of a temperature of the local set of the plural components.

13. The system according to claim 12, wherein the reflected signal from each sensor is uniquely modulated, and
wherein the data acquisition system is further configured to generate the real-time data in accordance with each of the modulated reflected signals as a temperature profile of the electric machine.

14. The system according to claim 13, wherein at least one of the sensors is disposed proximate to a local set of the plural components which experiences a temperature increase during a monitoring thereof.

15. A system to measure temperatures of components of an electric machine, the system comprising:
a first set of sensors, disposed along optical fibers and dispersed from one another at a first interval in a predetermined direction relative to the components, to each detect a temperature of corresponding local portions of the components;
a second set of sensors, disposed along optical fibers proximate to a hot-spot of the components and dispersed from one another at a second interval in the predetermined direction, to each detect a temperature of corresponding local portions of the components; and
a data acquisition system operably coupled to each of the first and second set of the sensors via the optical fibers to generate real-time temperature data in accordance with the detected temperatures.

16. A method of operating an electric machine by monitoring temperatures of components thereof, the method comprising:
installing a set of optical fibers, including sensors configured to detect temperatures of the components, at various positions proximate to the components; and
interrogating each of the sensors so as to generate real-time temperature data of the components, while the electric machine is in operation, in accordance with the detected temperatures.

17. The method according to claim 16, further comprising monitoring the real-time temperature data.

18. The method according to claim 16, further comprising repositioning at least one of the optical fibers so as to thereby position the corresponding sensors proximate to a predetermined local set of the components.

19. The method according to claim 16, further comprising comparing the real-time temperature data of the components with respective melting points of materials of the components.

20. The method according to claim 19, further comprising repairing and/or replacing the components in accordance with a result of the comparison.
